(19) United States
(12) Patent Application Publication
(10) Pub. No.: US 2015/0193806 A1
(43) Pub. Date: Jul. 9, 2015

(54) Reward Trading Platform for Generating Improved Customer Information and Feedback

(71) Applicant: Utopia Group Inc., Seattle, WA (US)

(72) Inventors: Paul Austin Tarailo, Arlington, WA (US); Ryan Robert Parnell, Lake Stevens, WA (US); David Aaron Kennedy, Plano, TX (US)

(21) Appl. No.: 14/589,073

(22) Filed: Jan. 5, 2015

Related U.S. Application Data
(60) Provisional application No. 61/923,717, filed on Jan. 5, 2014.
(60) Provisional application No. 61/923,574, filed on Jan. 3, 2014.

(51) Int. Cl. G06Q 30/02

(52) U.S. Cl. CPC G06Q 30/0227; G06Q 30/0217

(57) ABSTRACT

A reward trading platform using a Mobile Device Application and a control program running on a server that encourages customers to give more and more accurate feedback to a merchant by providing a virtually tradable and virtually redeemable reward coupon in exchange for providing feedback via a known platform that provides short and easy-to-take surveys combined with virtually tradable rewards via a group of mutually connected social contacts.

### CROSS-REFERENCE TO RELATED APPLICATIONS

This application claims the benefit of U.S. Provisional Appl. Nos. 61/923,574, filed 3 Jan. 2014, and 61/923,717, filed 5 Jan. 2014, which are incorporated herein by reference in their entireties.

### FIELD OF THE DISCLOSURE

The subject matter of the present disclosure relates generally to sales and marketing, and, more specifically, to the dispensing of rewards to customers on a mobile platform and generating customer feedback data.

### BACKGROUND

Consumer feedback is an important tool for a merchant to objectively evaluate its products and services. Such feedback may also include information on the types of consumers who purchase the products and services. Merchants have typically used customer-focused surveys to provide such feedback. Fast and accurate feedback is becoming more necessary and valuable to enable a merchant to respond more quickly and efficiently to changes in the business environment. As shown in FIGS. 1A-1B, merchants and retailers have begun making web-based surveys available to address these needs. As shown in FIG. 1A, merchants and retailers place a survey URL and information related to access to the surveys on customer receipts 10, i.e., a survey invitation via paper receipt (“receipt surveys”).

As shown in FIG. 1B, a typical receipt survey invitation process 15 includes the merchant displaying a URL linking to a web-site that hosts the survey on the paper receipt 10. The customer is then required to log-in to the survey website to gain access to the survey. The log-ins generally comprise the customer entering their personal information (name, email, etc.) and a code unique to the particular receipt 10. Additionally, because a small percentage of consumers typically respond to these forms of receipt surveys, merchants usually make the survey to be rather lengthy so they can glean as much information as possible from each customer. This requires the customer to complete several web pages of information.

To entice customers to visit their survey websites, merchants may sometimes hold a sweepstakes and enter the customer who completes the survey as an incentive. All the same, the odds of winning such sweepstakes rarely motivate consumers to fill out the surveys.

Surveys also may promise a discount on a future purchase. To facilitate the discount, the customer is given a validation code to write on the receipt 10 once the customer completes the survey. To redeem the discount, the customer presents the receipt 10 with the validation code to the merchant. This requires the customer to keep track of these receipts 10 and clutter their purse or wallet. Consequently, such survey invitations generally have low response rates and skewed to the customers who tend to complain the most. Furthermore, the surveys are often completed once the customer returns home and has more time to rummage for their receipt, complete the time-consuming login process, and take the long survey. This results in a delay in filling out the survey decreasing its accuracy.

The inventors have noticed that one of the reasons that the paper receipt survey invitations have such a low turn-out rate is that the typical survey is often too lengthy and time consuming to complete. Further, customers have no idea how long a survey will turn out to be or how long it will take to complete until the customer signs in and completes the survey. Additionally, there is no easy way for friends and family to share discounts thus generating new business.

Therefore, there exists a need for a platform that provides a better incentive for more customers to fill out useful surveys, to fill out the surveys with less delay, and to easily share the rewards with others.

### SUMMARY OF THE DISCLOSURE

According to the present disclosure, different rewards offered by different merchants can be traded by different customers in a network system. The rewards are offered for different surveys completed by the different customers. The different surveys to be completed and the different rewards associated with the surveys are stored in the network system, which can include a server system that has a database system and that interfaces with devices of the merchants and customers. Completion of the different surveys and offers of the different rewards to each of the different customers are then tracked in the network system.

With all of the completed surveys and rewards stored and tracked, there may be a point when one of the customers wants to trade one of his/her offers with another reward offered by the same merchant, by a different merchant, and/or to one or more other customers. In this instance, at least one request is obtained in the network system to trade the offer of at least one first of the different rewards for at least one first of the different customers. In response to the at least one request, one or more of the offers of one or more second of the different rewards are communicated in the network system, and at least one trade of the at least one first reward for at least one of the one or more second rewards is tracked in the network system for the at least one first customer. At least one redemption can also be obtained of at least one of the offers for at least one of the customers, and the at least one redemption by the at least one customer can be tracked in the network system.

To store the different surveys to be completed by the different customers, at least one server of the network system can provide one or more user interfaces to the different merchants to configure the different surveys and the different rewards.

To track the completion of the different surveys and the offers of the different rewards to each of the different customers, at least one mobile device of at least one of the customers can link to at least one of the surveys stored at at least one server in the network system. For example, a selection of the at least one survey can be received at the at least one server from the at least one mobile device, and the at least one server can retrieve the at least one survey for the at least one customer in response to the selection.

The at least one server obtains an indication of the completion of the at least one survey by the at least one customer and stores the at least one reward associated with the at least one survey. The at least one server presents the offer of the at least one reward to the at least one mobile device of the at least one customer and can additionally present a social media link of the at least one merchant to the at least one mobile device of the at least one customer.

To obtain the at least one request to trade the offer, at least one mobile device of the at least one first customer can link to the offer of the at least one first reward stored at at least one server in the network system. The at least one server obtain an indication of the at least one request to trade and presents information on the one or more second rewards from the at least one server to the at least one mobile device. Additionally, information on the offer to trade from the at least one first customer can be presented to one or more second of the customers associated with the one or more second rewards. In this case, fulfillment on the request can lead to a swap of the at least one first reward offered to the at least one first customer with at least one second of the rewards offered to at least one second of the customers. Then, the at least one first customer and the at least one second of the customers can be notified of the acceptance of the at least one trade.

According to the present disclosure, a communication device can be used in the trading of the different rewards offered to the different customers by the merchants. The device has one or more interfaces communicatively coupleable to the different merchants and customers. Memory tracks completion of different surveys for each of the different merchants and offers of different rewards for each of the different customers. A processing unit communicatively coupled to the one or more interfaces and the memory is configured to obtain at least one request to trade the offer of at least one first of the different rewards for at least one first of the different customers. The processing unit communicates one or more of the offers of one or more second of the different rewards for one or more second of the different customers in response to the at least one request and tracks at least one trade of the at least one first reward for the one or more second of the rewards between the at least one first customer and the one or more second customers.

According to the present disclosure, different rewards can be traded. The rewards are offered by different merchants to different customers for different surveys completed by the different customers. A first network device of a first of the different customers accesses a first of the different surveys associated with a first of the different merchants, and the first network device obtains a first reward for completion of the first survey from a second network device. The first network device obtains at least one request to trade the first reward with one or more second of the rewards and communicates the request to the second network device. Eventually, the first network device receives a response to the at least one request from the second network device.

According to the present disclosure, a first communication device has one or more interfaces and a processing unit. The one or more interfaces are communicatively coupleable to at least one second communication device. The processing unit is communicatively coupled to the one or more interfaces and the memory. The processing unit accesses, at the second communication device via the one or more interfaces, a first of the different surveys associated with a first of the different merchants and obtains, from the second communication device via the one or more interfaces, a first reward for completion of the first survey. The processing unit obtains at least one request to trade the first reward with one or more second of the rewards. The processing unit communicates, to the second communication device via the one or more interfaces, the at least one request and receives, from the second communication device via the one or more interfaces, a response to the at least one request.

### BRIEF DESCRIPTION OF THE DRAWINGS

FIG. 1A shows a paper receipt with a survey invitation according to the prior art.

FIG. 1B shows a flow diagram of a survey invitation process according to the prior art and the paper receipt of FIG. 1A.

FIG. 2 shows a communication schematic diagram of an embodiment according to the present disclosure.

FIG. 3A shows a flow diagram of a merchant login sequence.

FIG. 3B shows a merchant portal block diagram.

FIG. 4 shows an exemplary screen representation of the Store Locations option of FIG. 3B.

FIG. 5 shows a flow diagram of the Surveys & Offers option of FIG. 3B.

FIG. 6A shows an exemplary screen representation of the Current Offers option of FIG. 5.

FIG. 6B shows an exemplary screen representation of entering offer parameters according to FIG. 5.

FIG. 7A shows an exemplary screen representation of the Current Surveys option of FIG. 5.

FIGS. 7B and 7C show exemplary screen representations of creating and naming a survey according to FIG. 5.

FIG. 8A shows a flow diagram of the mobile application startup sequence.

FIG. 8B shows a flow diagram of the mobile application customer options.

FIG. 9 shows a customer receipt in accordance with an embodiment of the present disclosure.

FIG. 10A shows an exemplary customer survey screen in accordance with an embodiment of the present disclosure.

FIG. 10B shows an exemplary user's reward library screen in accordance with an embodiment of the present disclosure.

FIG. 11A shows an exemplary reward selection screen in accordance with an embodiment of the present disclosure.

FIG. 11B shows an exemplary reward redemption screen in accordance with an embodiment of the present disclosure.

FIG. 11C shows an exemplary successful reward redemption screen in accordance with an embodiment of the present disclosure.

FIG. 12A shows an exemplary trade offer selection screen in accordance with an embodiment of the present disclosure.

FIG. 12B shows an exemplary trade offer response screen in accordance with an embodiment of the present disclosure.

FIGS. 13A and 13B show exemplary survey report screens in accordance with an embodiment of the present disclosure.

FIG. 13C shows an exemplary offer report screen in accordance with an embodiment of the present disclosure.

FIG. 14 illustrates an exemplary network device or computer system according to the present disclosure.

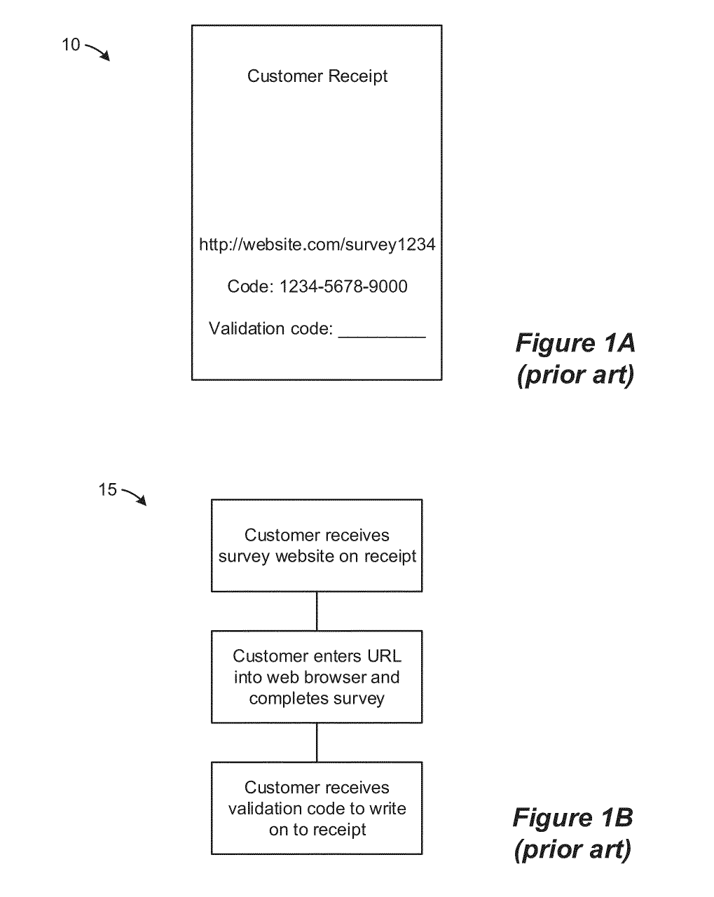

### DETAILED DESCRIPTION

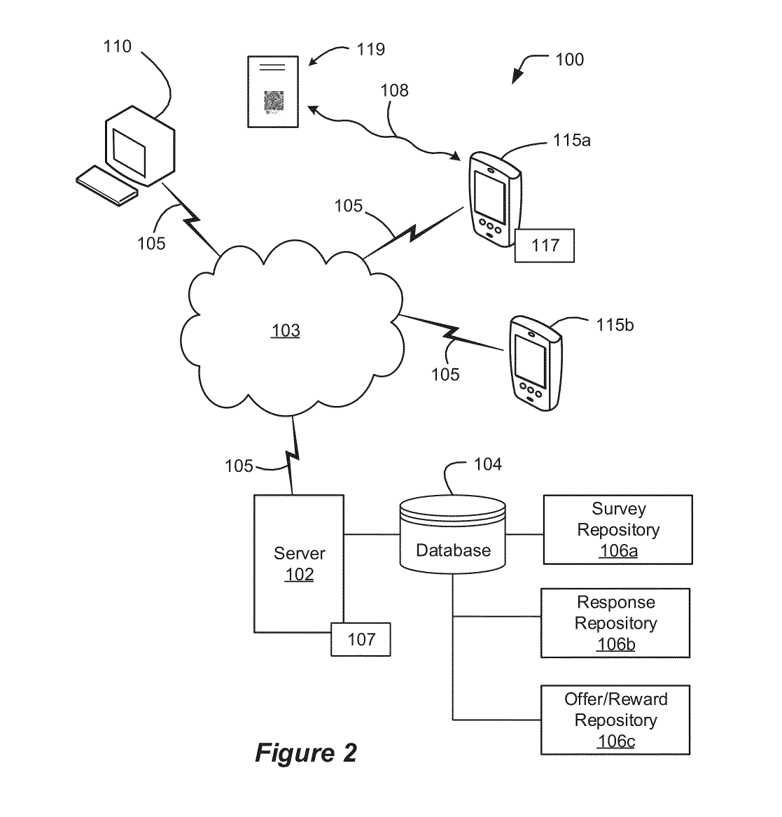

As solutions to overcome the problems mentioned previously, a customer loyalty platform is used to enhance a customer's experience. Referring to FIG. 2, a system 100 for a reward trading platform and generating customer feedback via a network 103 (e.g., the Internet) is schematically illustrated according to certain teachings of the present disclosure. The system 100 includes a server system 102 operatively coupled to a database system 104 having a survey repository 106a, a survey response repository 106b, an offer/reward repository 106c, among other database elements for tracking merchants, customers, surveys, offers, rewards, and the like as disclosed herein.

A merchant interface 110 and one or more mobile communications devices 115a-b can operatively couple to the server system 102 via wired or wireless connections 105. At least one of the mobile communication devices (e.g., 115a) may have an input to capture address data 108 from a merchant purchase receipt 119. In turn, the address data 108 may be used to access a specific survey within the server system 102, and the data 108 may be captured visually through a camera, entered manually via a keyboard or screen interface, or wirelessly via an antenna. The server system 102 and at least one of the mobile communication devices 115a-b run one or more programs that facilitate the downloading, administration, and uploading of a consumer survey and assignment of a reward as disclosed herein. For example, the mobile communication device (e.g., 115a) may run a reward-trading mobile device application 117, and the server 102 may run a control program 107 that manages the database 104 and acts to control the generation and distribution of the surveys, survey responses, trades, and rewards, for example.

The server system 102, merchant interface 110, and mobile communications devices 115a-b may comprise a fixed or semi-fixed memory medium such as a hard disc drive connected to the server system 102 or RAM inside or connected to the mobile communication devices 115a-b.

A number of different parties can interface with the server system 102 either directly or through the network 103. In particular, a number of different merchants may access the system 100 with the merchant interface 110 in order to create and activate different surveys and different reward offers. On the other side, a number of different customers may access the system 100 with communication devices to access and complete different surveys and receive different rewards being offered.

Briefly, a customer may access the system 100 with the mobile communications device 115a in order to, for example, scan his customer receipt 119, take a survey, receive a reward for completing the survey, and trade that reward with a user accessing a second mobile communications device 115b. It should be noted that the customer need not access the system 100 with the mobile communications device 115b in order to trade the customer's reward, but that the customer may trade via another interface (not shown) connected to the network 103, via a non-mobile device, e.g., a desktop computer.

It is not required that the user features for customer and the merchant be separate for separate types of entities. In some implementations, the merchant may also be the user in order to facilitate the trade or distribution of rewards. In other words, the customer may receive one reward for participating in a survey, and then trade that reward for another from the same merchant. Additionally, in some embodiments, rewards may be freely given among merchants, customers, and other users. In other words, rewards may be traded for nothing in return. Likewise, in some embodiments, more than one reward may be traded for a single reward.

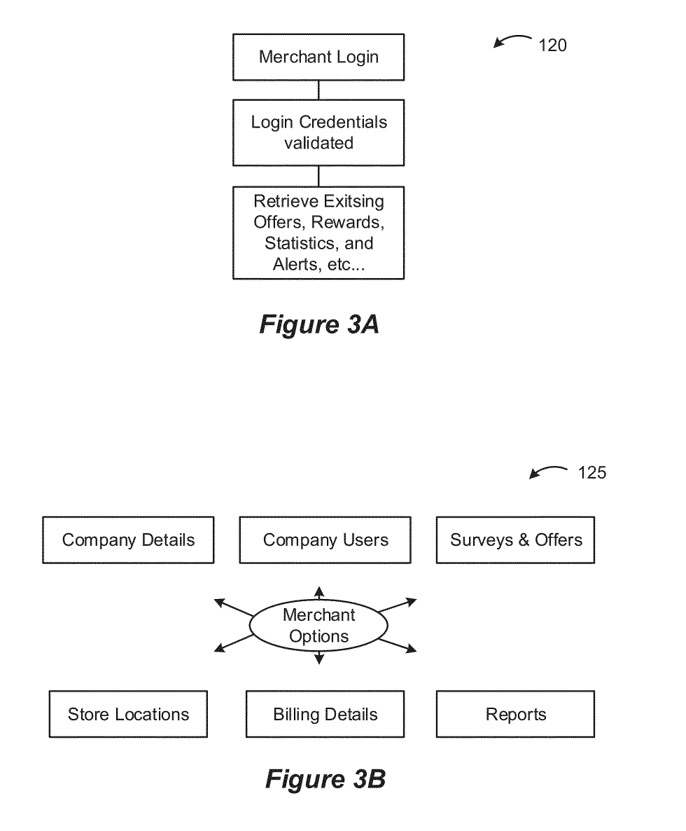

FIG. 3A shows a login sequence 120 for a merchant to login to the system 100 as in FIG. 2. Prior to accessing the system 100 to set up a survey or reward, the merchant must login to the control program 107. Once the control program 107 verifies the login credentials of the merchant, the system 100 retrieves offers, rewards statuses, alerts, and statistics pertaining to that merchant in the database 104. Although this may typically be done from the merchant interface 110 at the merchant's place of business over a secure internet connection 105, the merchant may use any network connection including connecting via mobile communication devices or may log directly into the server system 102. Once the login sequence 120 is complete, the merchant is directed to the merchant portal 125 (FIG. 3B).

In the merchant portal 125 of FIG. 3B, a merchant may access different functions of the control program (107: FIG. 2). Specifically, the merchant may access Company Details, Company Users, Billing Details, Store Locations, Surveys & Offers, and Reports sections from the merchant portal 125 among other sections. The Company Details, Company Users, and Billing Details sections may allow the merchant to set up the name of the merchant as it will appear on the rewards, set up payment methods and payment addresses for merchants to pay for using the software, as well as set up details pertaining to social networking, e.g., Facebook, Twitter, and Google+ accounts. These social networking links may be used in conjunction with generated surveys or rewards. For example, following the survey, the user will have the option to “like” and/or “follow” a merchant on their social sites, thus enabling merchants to better target their customers with media campaigns. The social networking links not only help to retain current customers but can help in gaining new customers when current customers share, (show off), their rewards on their own social networks enticing their friends to participate. e.g. “boom! I just got another free dessert!”

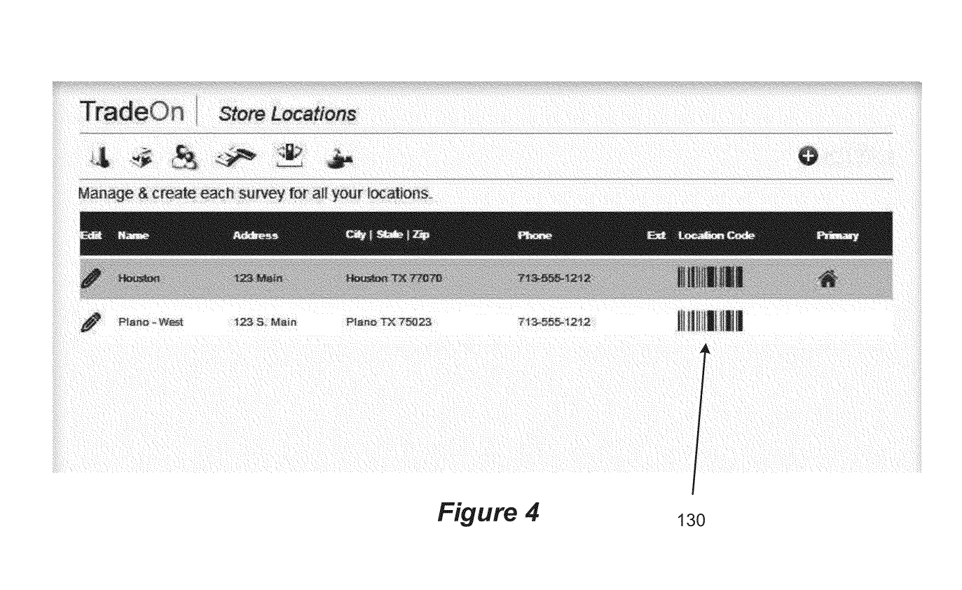

FIG. 4 shows an exemplary screen where a merchant may add, delete, or edit their various store locations. Each store location may be assigned a separate location code 130, or some or all of the stores of a merchant may use the same location code 130. Location codes 130 are generated by the control program 107 and may be generated as a sequential number or a random number for greater security. In one embodiment, the location code 130 is a four digit number. By clicking on the location code 130, a merchant may be given the option to print out the location code 130 as a bar code, QR (quick response) code, or other digital, pictorial, or numerical representation of the location code 130. The location code 130 will be used in the reward redeeming process as described in detail below.

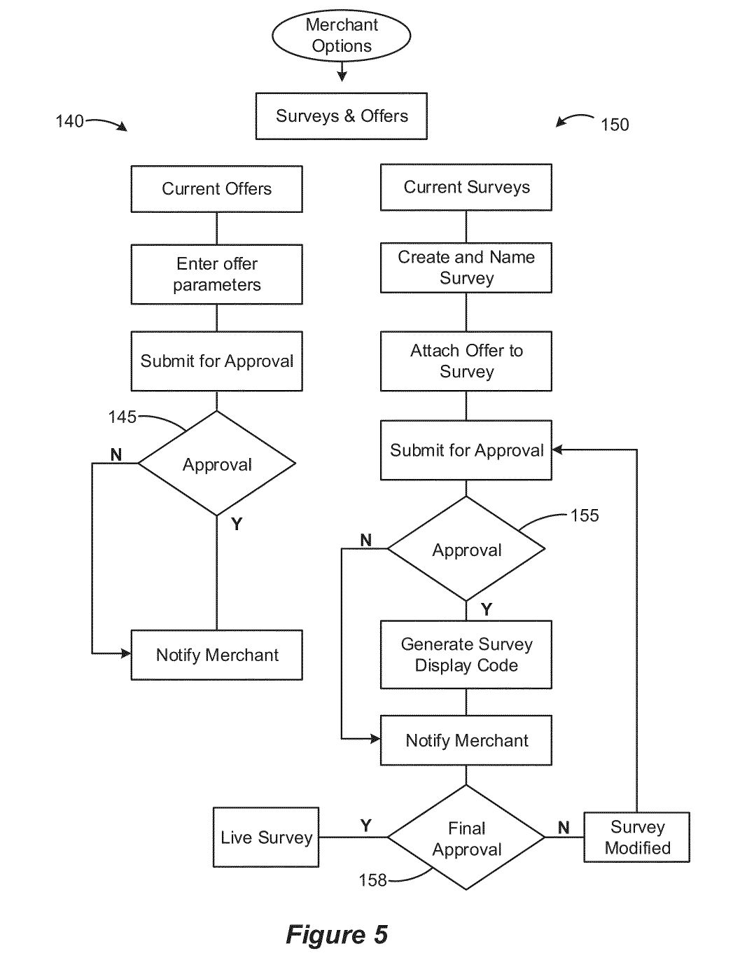

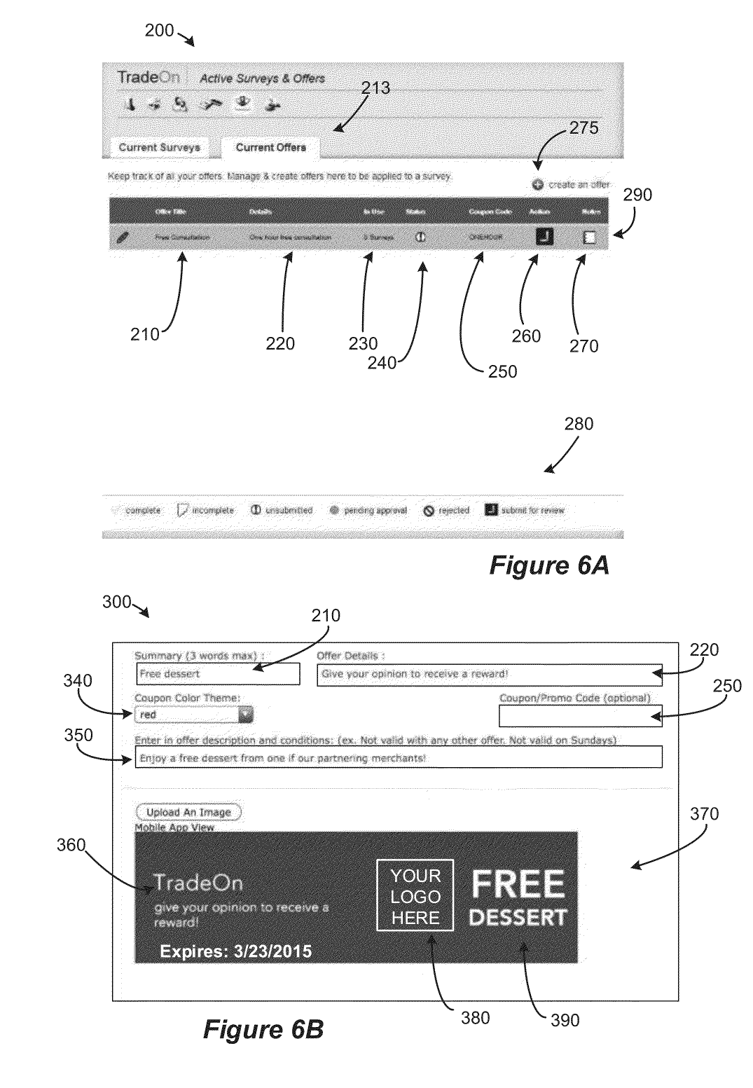

FIG. 5 shows how a merchant can use the Surveys & Offers options from the merchant portal 125 of FIG. 3B. As shown in FIG. 5, the merchant can access a Current Offers flow 140 and a Surveys flow 150. FIGS. 6A and 6B are also referred to with the Current Offers flow 140 and will be discussed together. Note, a merchant may move between the Offers flow 140 and the Surveys flow 150 by selecting a tab 213 on the Active Surveys & Offers screen 200.

The Current Offers flow 140 shows the process for a merchant to add, delete, or edit an offer. The merchant enters parameters of an offer and submits it for approval (Decision 145). If approved, the merchant is notified by the system 100.

The Current Surveys flow 150 shows the process for a merchant to add, delete, or edit a survey. The merchant creates and names a survey and attaches a current offer to the survey. An approved offer is not necessarily required for a merchant to enter in parameters for a survey. However, it should be noted that an approved offer may be required to be attached to a survey before the survey can be submitted for approval. In another embodiment, an unsubmitted offer may be submitted together with a survey to have both offer and survey approved simultaneously.

The generated survey is submitted for approval by the system 100 (Decision 155). If approved, the system 100 generates a survey display code and notifies the merchant. A final approval process (Decision 158) can then be performed to either may the survey live or to modify the survey further.

In the Current Offer flow 140, a merchant can access various screens of the system 100. For example, a screen 200 in FIG. 6A can display all active offers, i.e., complete offers as well as all of the offers which are still in progress. To create a new offer, a merchant may click a button 275 which opens a screen 300 in FIG. 6B. Here, the merchant enters parameters associated with the offer, for example, a three word summary 210, although this is not strictly necessary as other length summaries may be used as well. Offer details 220, and restrictions and conditions 350 are also entered. The color theme for the offer may be determined from a drop-down menu 340. As these parameters are input into the screen 300, an offer 370 is automatically and dynamically generated. The dynamically generated offer may also have some auto-populated fields such as the merchant name 360. In some embodiments, the name 360 is modifiable, i.e., the merchant may set this value, however in other embodiments, this value is set by a control program administrator. The merchant may also add a logo 380 or other graphic to the offer 370. An optional promotion code 250 may also be input into the offer parameters. The promotion code 250 may be omitted from the offer display 370 because this value may only be revealed once a customer or trade recipient redeems the reward.

It should be noted that the term “offer” as used herein describes the offer of a reward as set-up prior to awarding the reward to its recipient, e.g., when a customer completes a survey and the merchant's offer is added to the customer's reward library. It should also be noted that the terms reward and coupon may be used synonymously.

In some embodiments, the rewards may have no expiration date. In other embodiments, the merchant may specify the reward's expiration, and in yet other embodiments, the rewards may expire a fixed number of days from the expiration of the survey, for example.

Referring back to FIG. 6A, details of the offer including a status 240 may be displayed on the current offer screen 200 in an offer detail line 290. Once all of the required parameters for the merchant's offer are entered, the offer status 240 changes from “incomplete” to “unsubmitted.” An action icon 260 displayed on screen 200 is a desirable feature as this quickly tells the merchant the next step in the offer creation flow each offer is in. A legend 280 may also be displayed on current offer screen 200 as an easy reference to the merchant.

Once an offer's status 240 is “unsubmitted,” the merchant may click on the “submit for review” icon 260. Referring back to FIG. 5, the administrator is then notified of an offer approval request (Decision 145). Notification may be by one or more of various means such as SMS, email, a pop-up screen on the server system or a mobile communication device, or the like. The administrator may approve the offer, reject the offer, or modify the offer. If the administrator modifies the offer, the merchant may be required to view the offer again and re-approve the offer. Otherwise, the merchant may further edit the offer and re-submit it for approval. The merchant may be notified in the same ways as the administrator, e.g., SMS, email, web-browser, interface pop-up, etc. which applies to all administrator, merchant, and user notifications described herein.

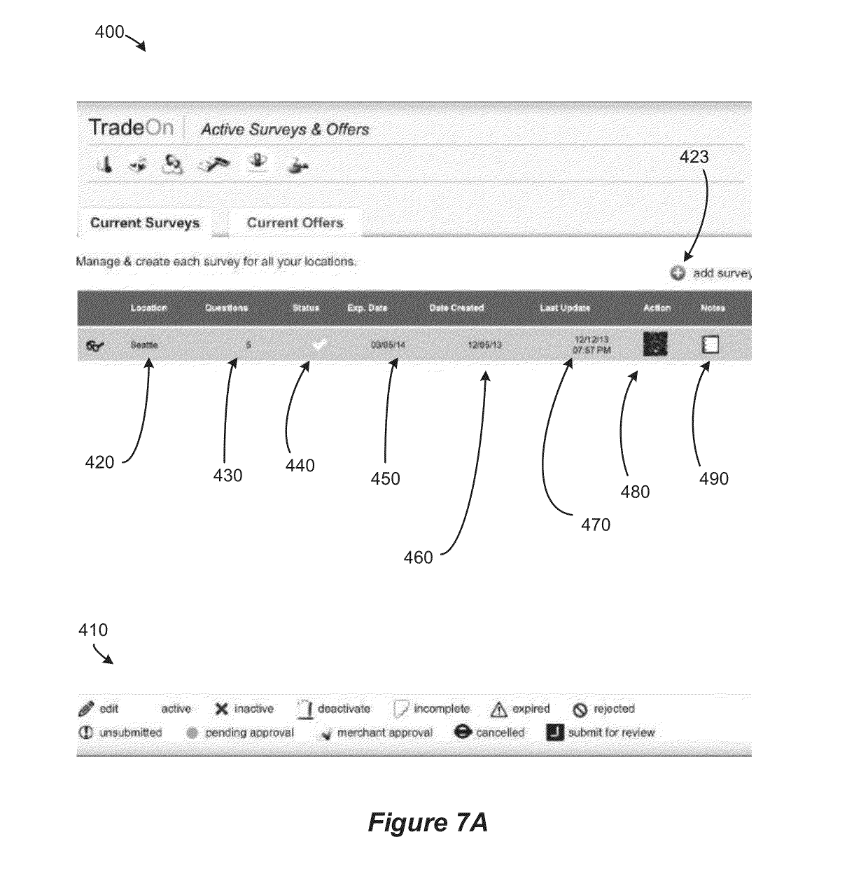

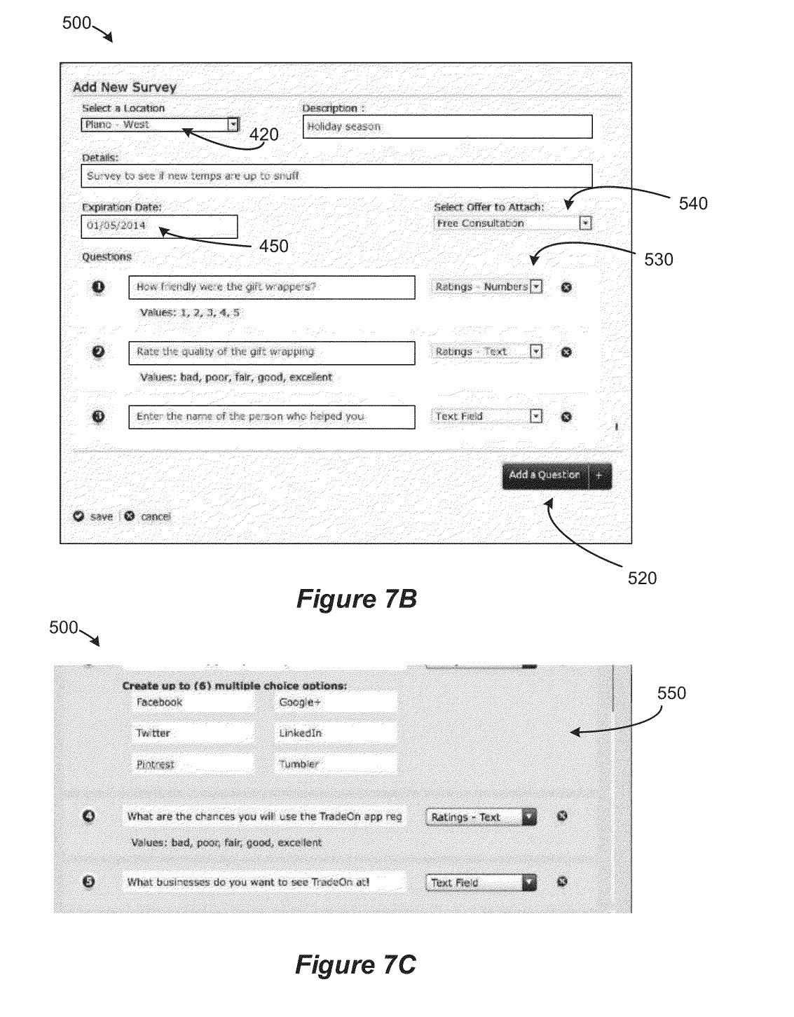

As noted previously in FIG. 5, the Current Survey flow 150 includes the steps of preparing a short survey, attaching an offer, submitting for approval (Decision 155), generating a survey display code (e.g., 605 in FIG. 9), and receiving final approval to activate the survey/offer combination. In the Current Survey flow 150, a merchant can access various screens of the system 100. For example, FIGS. 7A-7C show screens for a merchant to add, delete, or edit surveys.

As shown in FIGS. 7A-7C, entry of the survey parameters is similar to entry of the offer parameters described above. A new survey is added by clicking the “add survey” button 423. Each survey may have a location 420 associated with it, a description, details, an offer 540, and an expiration date 450. In some embodiments, the expiration date does not appear on the offer, but will affix to the reward once it is assigned to a user's reward library. In some embodiments, the survey will expire a fixed number of days, e.g., ninety, after the creation of the survey. The detail line for each survey, like the offer detail lines 290 for each offer under the Current Offers tab, also include a status icon 440, an action icon 480, as well as a legend 410.

To create a survey 500, a merchant or administrator, will select the “add a question” button 520. To aid in usability for both the survey taker and survey creator, the survey is created from a template of question forms. Additionally, the number of questions are limited. The inventors have noticed that a short survey of one to five questions increases customer participation and increases the likelihood of the consumer completing the survey at the time of purchase when the experience is fresh in the customer's mind thereby providing more accurate feedback.

FIGS. 7B and 7C show examples of several template question forms. The form for each question may be selected from a drop-down menu 530. For example, a ratings-numbers form (question 1 in FIG. 7B) comprises a space for the survey creator to type in a question where a numerical response from 1-10 is required. In FIG. 7B, question 2 shows a form that requires a text response with pre-determined values, e.g., good, poor, fair, bad, etc. The survey taker may select one of the text responses from a list, or in some embodiments, type the response.

Open questions may also be included in the template, such as question 3 in FIG. 7B. This question prompt allows the survey taker to type a general response. In some embodiments, the number of characters allowed is limited in either or both the prompt and the response. For example, a prompt may be limited to forty characters while the answer may be limited to 15. FIG. 7C shows an example of a multiple choice response limited from 1 to 6 possible answers.

Surveys may have pre-populated questions and answers pertaining to specific topics. For example, if there are five questions, one question may always be a “comment/suggestion” in text form leaving four more questions to broadly explore a specific topic e.g., “cleanliness,” “customer service,” “product quality,” and “atmosphere.” These questions and answers may be defaults only and may be changeable. This adds value to the mobile device application for the merchants by assisting the merchants with pre-populates questions and answer forms when a merchant begins to create a new survey. If the merchant would like to ask a different question, they may be able to simply change the question and then enter their own answers. Of course, different industries will have different questions and answers.

Once the survey questions are saved and an offer attached, the status 440 will change from “incomplete” to “unsubmitted.” At this point, the survey may be submitted to the administrator for approval (Decision 155 in FIG. 5). As with the offer, the administrator is notified through similar means. The administrator may then approve, reject, or modify the survey. If approved, a survey display code 605 (FIG. 9) is generated and the survey goes back to the merchant for one final approval (Decision 158) before activating the survey and taking it live and allowing users to receive the reward for completing the survey. The merchant may download and save the survey display code 605 for use in conjunction with a POS or other receipt tracking system.

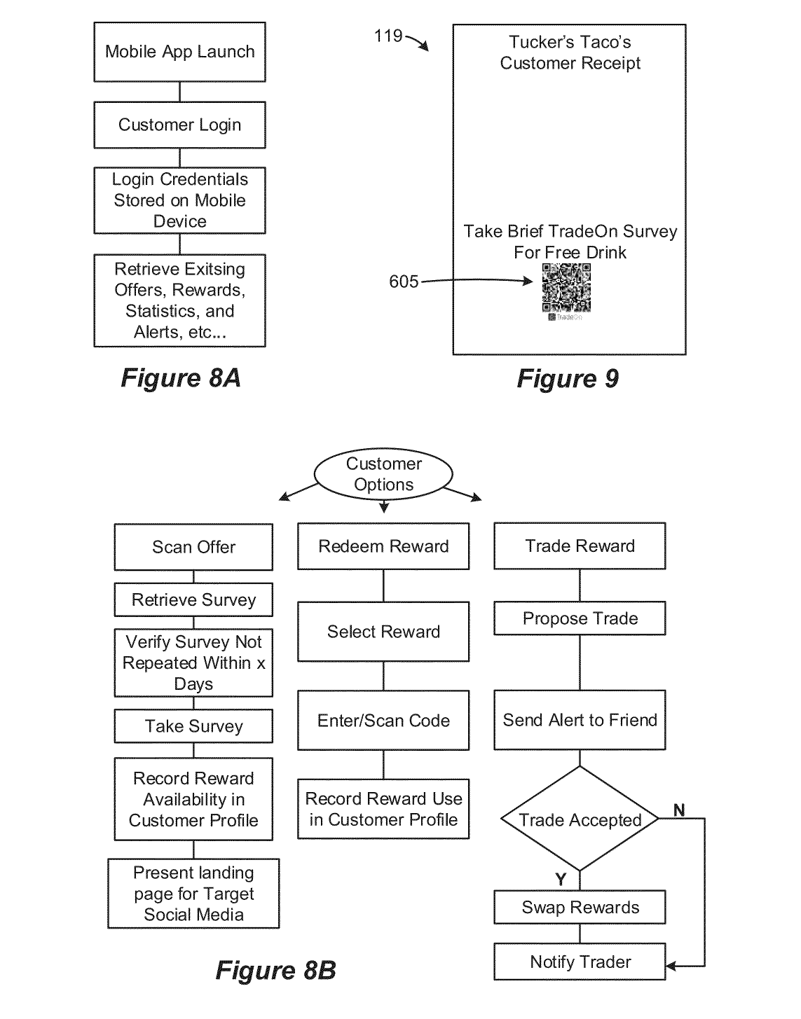

FIGS. 8A and 8B show flow diagrams of the mobile communication device application program 117 of FIG. 2. Once downloaded on the mobile device 115, the application program 117 may require the user to login and provide certain demographic data. Demographic data may include the information included in a social media shared login such as name, email, gender, and date of birth, etc. The login data and credentials may be stored on the mobile device 115. In this manner, a user will not need to type any login information when launching the application 117. As such, a customer may quickly and easily access the scan capability of the mobile device increasing the likelihood that a customer will immediately scan the merchant's survey code and participate in the survey. Once the user is logged in and their login credentials verified, the application may retrieve initial data such as existing offers, surveys, rewards, alerts, statistics, etc.

In some embodiments, certain rewards may be initially populated into a user's reward library, in some embodiments, the initial rewards may be populated based on the provided demographic data. In some embodiments, rewards may only be traded among users who have downloaded the mobile application. The application makes use of its own “mutual friends” list. This is a group of users that have mutually agreed to friend each other on or through the mobile device application. Mutual friends may have access to view each other's reward libraries. A user may search through each of her friends' reward libraries for a reward that she would like to initiate a trade. The user may search all of her friends for a particular friend or may search all of her friends for a specific reward. In one embodiment, a user may search a consolidated library of all users. In this embodiment, users who are not mutual friends may trade anonymously. Additionally, users may invite other users by typing their email or by designating a contact list or certain people in the mobile device's contact list as an invite group.

FIG. 8B shows the flow of three main functions of the mobile application (117: FIG. 2), including Scan Offer, Redeem Reward, and Trade Reward. These functions are discussed in further detail below. To scan an offer, as shown in FIG. 9, an input (e.g., a camera) of the mobile device 115 focuses on a printed survey display code 605 such as a bar code or QR code on a customer receipt 119. The data directs the application 117 to retrieve the corresponding survey from the system's survey database 104. In some embodiments, the survey display code 605 comprises a web address that directs mobile devices 115 that do not have the mobile application 117 installed to a website where the application 117 may be downloaded. This further increases the chances of the survey being immediately taken.

In other embodiments, the survey display code 605 is printed on a predominant surface in the merchant's business. Such surfaces may include food trays, promotional signs, bags, product wrapping, etc. In other embodiments, the survey display code is embedded in an RFID or NFC device and scanned wirelessly from an antenna in the mobile device.

Referring back to FIG. 8B, once the survey is identified, the mobile application 117 or the control program 107 verifies that the user requesting the survey has not taken the same survey within a particular time period (e.g., number of days) since completing the same survey. In some embodiments, the merchants determine the time period for a given survey. In other embodiments, the time period is a default number of days, e.g., 30 days. After it is determined that the user has not taken the same survey within the set time period, the user completes the survey.

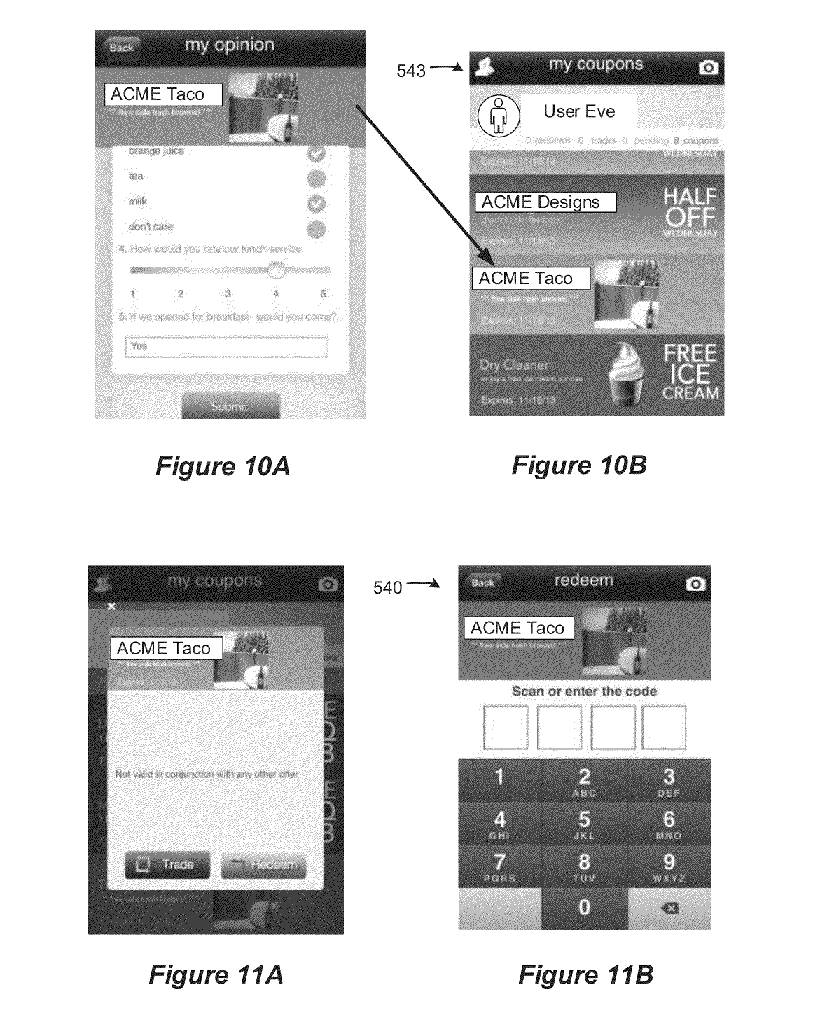

As an example, FIG. 10A shows an exemplary survey that is ready for submission. Once the survey is submitted and the results uploaded to the system's response repository 106b, the reward associated with survey is transferred to the user's reward library 106c and is communicated to the customer with a reward screen, such as in FIG. 10B. Additionally, the user may be presented with the landing page for the merchant's target social media. Because the user has just been given a nice deal associated with the reward, it is more likely that the user will want to join the merchant's social media, e.g., Facebook or Twitter page.

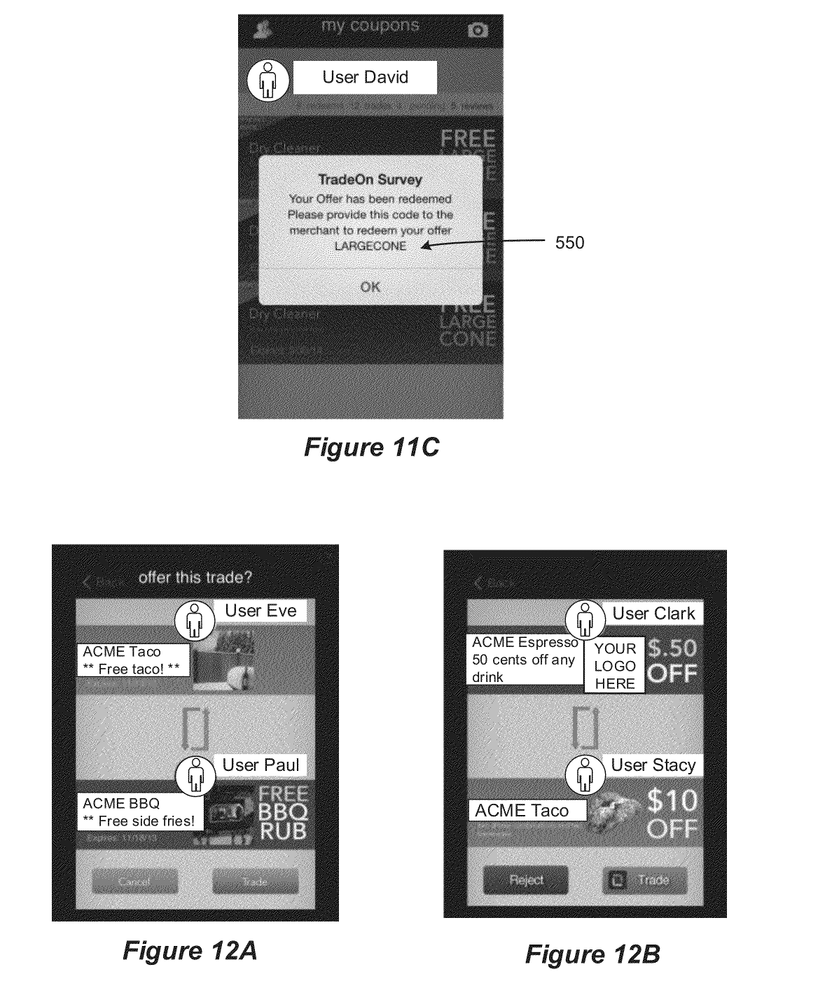

To redeem a reward, a user may tap on the reward or slide the reward in one direction, e.g., to the left, and select a redeem icon on a following screen as in FIG. 11A. To then redeem the reward in a following screen of FIG. 11B, for example, a user may either manually enter the location code or may scan the bar or QR location code by pressing the camera icon 540. Additionally, the code may be scanned wirelessly, as described above, through an RFID or NFC for example. The result is shown in the screen of FIG. 11C. A resulting message lets the merchant know that the reward has been redeemed and cannot be re-used. Additionally, while setting up the parameters of the offer, the merchant may specify that the redeemer can present the merchant with a promotion code 550. Such codes are useful for interfacing with a merchant's POS system.

To trade the reward on the screen in FIG. 10B rather than redeem the reward, the user may again tap on the reward or may swipe the reward in the opposite direction as a redeem swipe, e.g., to the right. The user may then select to trade the reward on the screen in FIG. 11A. At this point, the user accesses a trading screen of FIG. 12A where the user may then select another user's reward to propose a trade. Once the trade is proposed, a notification may be sent to the prospective trading user. In a counterpart screen of FIG. 12B, the particular user is presented with the option to trade and may then accept the trade or reject the trade.

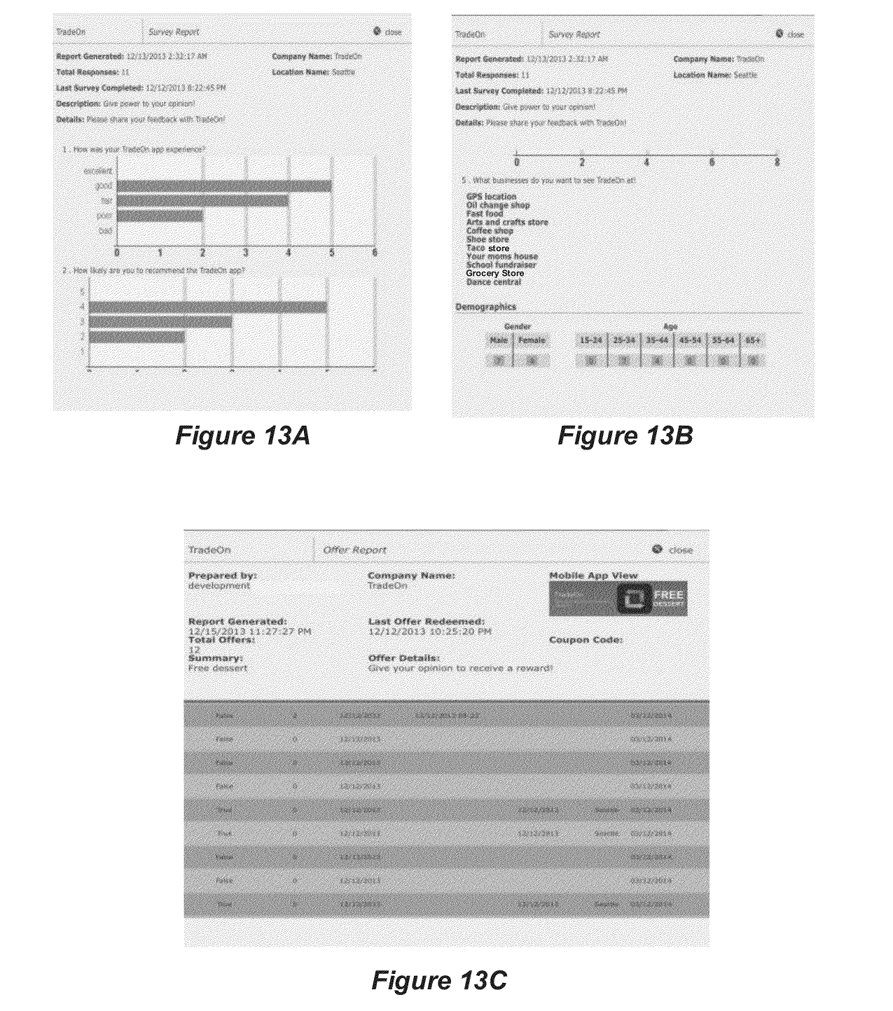

Various reports are very useful marketing tools for the merchant. For example, FIGS. 13A-B show Survey Reports, and FIG. 13C shows Offer Reports. The merchant may access the reports via the network 103 or may request the reports to be mailed or emailed. Additionally, the reports may be downloaded in an easy to use spreadsheet format, e.g., Excel. The survey reports aggregate the survey responses and present them in a way that merchants can easily use. Additionally, a roll-up of redeeming users' demographics let merchants know more about the type of people visiting their business and where to focus their advertising budget.

The Offer Reports in FIG. 13C let a merchant know if the rewards that they are offering are being used, if the rewards are being traded, and where and when they are being redeemed. Merchants can quickly get a feel for how many rewards were used and how many outstanding rewards are still active. The Offer Report may include information such as number of offers redeemed, number of trades, the date awarded, the date traded, the date redeemed, the redeem location, and the offer's expiration date.

One skilled in the art will understand that the disclosed device applications and/or programs will comprise instructions that can be stored on non-transitory machine-readable media, such as magnetic, optical, or solid-state discs, integrated circuits, tapes, etc., and which can be executed on the mobile device. Examples of likely storage devices having machine-readable media which would store the disclosed mobile device applications include the mobile device 115 (e.g., after it is downloaded into memory), or an Internet or other network server, such as a merchant's server or an app store server, which a user can access to download the reward trading application to his mobile device as noted previously. However, other storage devices could include disks, memory sticks or modules, which may be portable or which may be integrated within other computers or computer systems.

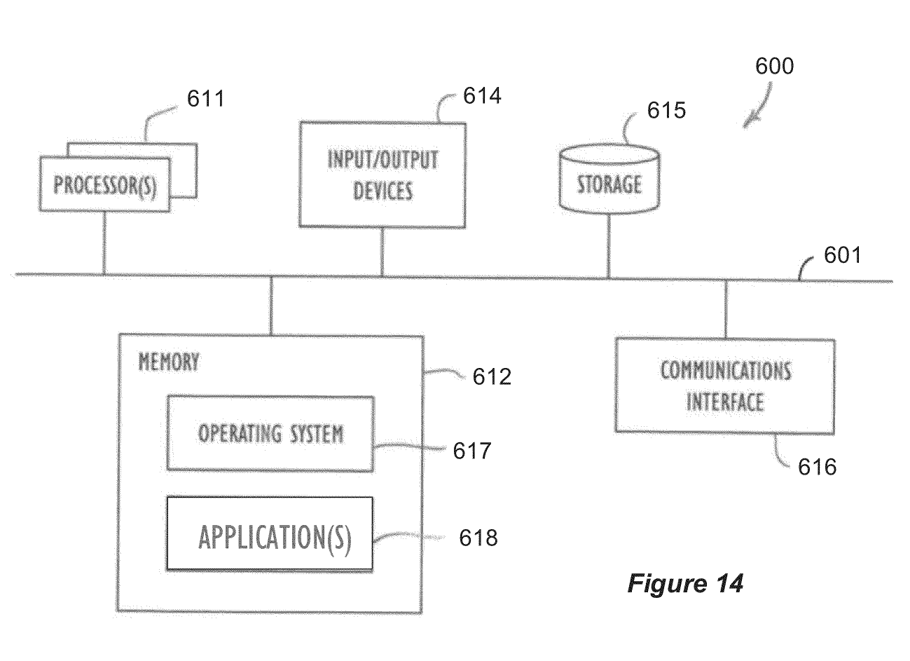

FIG. 14 illustrates an exemplary network device or computer system 600 according to an embodiment of the present disclosure for use as a server system, communication device, mobile device, network device, etc., as disclosed herein. The computer system 600 can include a processing unit with one or more processors 611. Additionally, the system 500 has memory 612, input/output devices 614, storage 615, and communication interfaces 616—all connected by a communication bus 601.

The input/output devices 614 may include input devices such as a mouse, keyboard, touchscreens, and the like, and output devices such as monitors, displays, and the like. Storage device 615 stores application programs and data for use by the computer system 600. Typical storage devices include hard-disk drives, flash memory devices, optical media, network and virtual storage devices, and the like. The communication interfaces 616 may connect the computer system 600 to any kind of data communications network, including either wired networks, wireless networks, or a combination thereof. In one embodiment, the communication interfaces 616 may be utilized to broadcast/receive event updates to one or more installations, receive weather data, and the like.

The memory 612 is preferably a random access memory sufficiently large to hold the necessary programming and data structures of the disclosed subject matter. While the memory 612 is shown as a single entity, it should be understood that the memory 612 may in fact comprise a plurality of modules, and that memory 612 may exist at multiple levels, from high speed registers and caches to lower speed but larger DRAM chips.

Illustratively, the memory 612 contains an operating system 617. Memory 612 is also shown containing application(s) 618 which, when executed by the processor 611, provide support for generating the graphical user interfaces, facilitates user interaction with the user interfaces as described herein, and broadcasts/receives data related to surveys, reward trading, and other processes, as described herein.

In one embodiment, the disclosed subject matter can be implemented as a program product for use with a computerized system. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a wireless network. The latter embodiment specifically includes information downloaded from the Internet and other networks. Such computer-readable media, when carrying computer-readable instructions that direct the functions of the present disclosed subject matter, represent embodiments of the present disclosed subject matter.

In general, the routines executed to implement the embodiments of the disclosed subject matter, may be part of an operating system or a specific application, component, program, module, object, or sequence of instructions. The computer program of the present disclosure typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the disclosed subject matter. However, it should be appreciated that any particular program nomenclature that follows is used merely for convenience, and thus the disclosed subject matter should not be limited to use solely in any specific application identified and/or implied by such nomenclature.

Although particular embodiments have been shown and described, it should be understood that the above discussion is not intended to limit the present disclosure to these embodiments. It will be obvious to those skilled in the art that various changes and modifications may be made without departing from the spirit and scope of the present disclosure. Thus, the present disclosure is intended to cover alternatives, modifications, and equivalents that may fall within the spirit and scope of the present disclosure as defined by the claims.

What is claimed is:

1. A method of trading different rewards offered by different merchants to different customers for different surveys completed by the different customers, the method comprising:
storing, in a network system, the different surveys to be completed by the different customers;
storing, in the network system, the different rewards associated with the different surveys;
tracking, in the network system, completion of the different surveys and offer of the different rewards to each of the different customers;
obtaining, in the network system, at least one request to trade the offer of at least one first of the different rewards for at least one first of the different customers;
communicating, in the network system, one or more of the offers for one or more second of the different rewards in response to the at least one request; and
tracking, in the network system, at least one trade of the at least one first reward for at least one of the one or more second rewards for the at least one first customer.

2. The method of claim 1, wherein storing, in the network system, the different surveys to be completed by the different customers comprises providing, from at least one server in the network system, one or more user interfaces to the different merchants to configure the different surveys.

3. The method of claim 2, wherein storing, in the network system, the different rewards associated with the different surveys comprises providing, from the at least one server in the network system, the one or more user interfaces to the different merchants to configure the different rewards offered for the different surveys.

4. The method of claim 1, wherein tracking, in the network system, the completion of the different surveys and the offer of the different rewards to each of the different customers comprises linking a mobile device of one of the customers to one of the surveys stored at at least one server in the network system; obtaining at the at least one server an indication of the completion of the survey by the customer; and storing, at the at least one server for the customer, the reward associated with the survey.

5. The method of claim 4, wherein tracking, in the network system, the completion of the different surveys and the offer of the different rewards to each of the different customers comprises presenting the offer of the reward from the at least one server to the mobile device of the customer.

6. The method of claim 5, wherein presenting the offer of the reward from the at least one server to the mobile device of the customer further comprises presenting a social media link of the merchant for the survey to the mobile device of the customer.

7. The method of claim 4, wherein linking the mobile device of the customer to the survey stored at the at least one server in the network system comprises receiving a selection of the survey at the at least one server from the mobile device and retrieving, at the at least one server, the survey for the customer in response to the selection.

8. The method of claim 1, further comprising obtaining, in the network system, at least one redemption of at least one of the offers for at least one of the customers; and tracking, in the network system, the at least one redemption by the at least one customer.

9. The method of claim 1, wherein obtaining, in the network system, the at least one request to trade the offer of the at least one first reward for the at least one first customer comprises linking at least one mobile device of the at least one first customer to the offer of the at least one first reward stored at at least one server in the network system; obtaining an indication of the at least one request to trade at the at least one server; and presenting information on the one or more second rewards from the at least one server to the at least one mobile device.

10. The method of claim 9, wherein communicating, in the network system, the one or more offers of the one or more second rewards in response to the at least one request comprises presenting information on the offer to trade from the at least one first customer to one or more second of the customers associated with the one or more second rewards.

11. The method of claim 1, wherein tracking, in the network system, the at least one trade of the at least one first reward for the one or more second rewards for the at least one first customer comprises swapping the at least one first reward offered to the at least one first customer with at least one second of the rewards offered to at least one second of the customers with in response to an acceptance of the at least one trade.

12. The method of claim 1, wherein tracking, in the network system, the at least one trade of the at least one first reward for the one or more second rewards for the at least one first customer comprises notifying the at least one first customer and at least one second of the customers of an acceptance of the at least one trade.

13. The method of claim 1, wherein storing, in the network system, the different rewards associated with the different surveys further comprises linking the different rewards with social networking sources associated with the different merchants.

14. A communication device, comprising:
one or more interfaces communicatively coupleable to different merchants and different customers;
memory tracking completion of different surveys for each of the different merchants and offers of different rewards for each of the different customers; and
a processing unit communicatively coupled to the one or more interfaces and the memory, the processing unit configured to:
obtain at least one request to trade the offer of at least one first of the different rewards for at least one first of the different customers;
communicate one or more of the offers of one or more second of the different rewards for one or more second of the different customers in response to the at least one request; and
track at least one trade of the at least one first reward for the one or more second of the rewards between the at least one first customer and the one or more second customers.

15. A method of trading different rewards offered by different merchants to different customers for different surveys completed by the different customers, the method comprising:
accessing, with a first network device of a first of the different customers, a first of the different surveys associated with a first of the different merchants;
obtaining, at the first network device from a second network device, a first reward for completion of the first survey;
obtaining, at the first network device, at least one request to trade the first reward with one or more second of the rewards;
communicating, from the first network device to the second network device, the at least one request; and
receiving, at the first network device from the second network device, a response to the at least one request.

16. A first communication device, comprising:
one or more interfaces communicatively coupleable to at least one second communication device; and
a processing unit communicatively coupled to the one or more interfaces and the memory, the processing unit configured to:
access, at the second communication device via the one or more interfaces, a first of the different surveys associated with a first of the different merchants;
obtain, from the second communication device via the one or more interfaces, a first reward for completion of the first survey;
obtain at least one request to trade the first reward with one or more second of the rewards;
communicate, to the second communication device via the one or more interfaces, the at least one request; and
receive, from the second communication device via the one or more interfaces, a response to the at least one request.
